(19) United States
(12) Patent Application Publication
(10) Pub. No.: US 2008/0199662 A1
(43) Pub. Date: Aug. 21, 2008

(54) GRAPHIC MAT AND METHOD OF MANUFACTURE

(76) Inventor: Mark H. Gross, Fort Lauderdale, FL (US)

Correspondence Address: PATENT GROUP;C/O DLA PIPER US LLP, 203 N. LASALLE ST., SUITE 1900, CHICAGO, IL, 60601, US

(21) Appl. No.: 12/031,507

(22) Filed: Feb. 14, 2008

Related U.S. Application Data
(60) Provisional application No. 60/890,493, filed on Feb. 18, 2007.

(51) Int. Cl. B32B 3/00; B29C 65/00

(52) U.S. Cl. 428/195.1; 156/277

(57) ABSTRACT

The present invention relates to multi-layer mats that display a graphic image printed on an intermediate layer of the mat. Mats of the present invention have a base layer, an intermediate graphic layer having graphics thereon, and a top layer. The base layer is preferably made of rubber. The intermediate graphic layer is preferably made of polystyrene or polyvinyl chloride. The top layer is preferably optically clear. The layers of preferred mats preferably have adhesive layers therebetween, and are laminated together.

### RELATED APPLICATIONS

This application claims the benefit of U.S. Provisional Patent Application Ser. No. 60/890.493, filed on Feb. 18, 2007, currently pending, the disclosure of which is hereby incorporated by reference in its entirety

### BACKGROUND

The present invention generally relates to image bearing mats. More particularly, the present invention relates to multi-layer mats that display a graphic image printed on an intermediate layer of the mat.

The advertising of goods and services can include displays of information including text and graphics to assist the consumer in making purchasing decisions. There is a wide range of modes of advertising, including television, radio, print including newspapers and magazines, brochures, and point-of-purchase literature and displays. Point-of-purchase literature and displays include brochures, cards, fliers, signs and the like, located at or in proximity to the goods or services being provided.

Mats that include text and graphics related to a product are one type of display advertising. Typically, such mats are placed on the floor or on a countertop surface in proximity to the location of the related product. One type of mat is textile based, where the mat is provided with graphics by colorizing the textile pile and arranging in a way to create meaningful content. A second type of mat for indoor use is a printed vinyl sheet with an adhesive backing thereon. The adhesive is typically covered with a releasable protective sheet until the mat is to be used, and then secures the mat to a surface after the releasable protective sheet is discarded. A third type of mat includes a vinyl sheet on which text or graphics are printed. The vinyl sheet is typically bonded to a rubber base using a vulcanization or heat process. Because the vinyl sheet and the uncured rubber are heat vulcanized, the stratas meld together as one.

While known mats can be used to provide point-of-purchase display information for use in stores, there are drawbacks to these devices. For example, with respect to the vinyl sheet bonded to rubber, the vulcanization process tends to degrade the graphic quality. Further, manufacturing such mats requires the vulcanization of the laminate to meld the layers to form a unitary rubber mat. Vulcanization equipment is specialized, and impractical for other than large manufacturing facilities. This equipment is typically too costly for even large print shops that conventionally make signs using large format printers and laminators. In addition, operational constraints are costly for heat vulcanization due to air quality requirements arising from control and filtering of fumes released in the vulcanization process.

### BRIEF SUMMARY

The present invention relates to multi-layer mats that display a graphic image printed on an intermediate layer of the mat.

In one aspect, multi-layer graphic mats of the present invention have a base layer, an intermediate graphic layer attached to the base layer, and a top layer attached to the intermediate layer. The base layer has a first base surface and a second base surface. The intermediate graphic layer has a first intermediate surface with graphics thereon and a second intermediate surface. The top layer has a first top surface and a second top surface.

In another aspect, multi-layer graphic mats of the present invention have an intermediate graphic layer, and an top layer attached to the intermediate layer. The top layer has a first top surface and a second top surface. The intermediate graphic layer has a first intermediate surface with graphics thereon, and a second intermediate surface having an adhesive layer attached thereto. The adhesive layer will stick to either the first top surface of a second top layer or to a rubber base layer.

In a third aspect, the present invention provides methods of manufacturing multi-layer graphic mats. For example, one preferred process includes the steps of providing a base layer material having a first base surface and a second base surface, providing an intermediate graphic layer material having a first intermediate surface and a second intermediate surface, and providing an top layer material having a first top surface and a second top surface. The process also includes printing graphics onto the first intermediate surface of the intermediate graphic layer. The process further includes laminating the base layer, the intermediate graphic layer, and the top layer to form a multi-layer graphic mat.

### BRIEF DESCRIPTION OF SEVERAL VIEWS OF THE DRAWINGS

FIG. 1 is a top perspective partially cut-away view of a multi-layer graphic mat according to the present invention.

FIG. 2 illustrates a bottom perspective exploded view of the multi-layer graphic mat of FIG. 1.

FIG. 3 is a schematic illustration of a process for manufacturing tile multi-layer laminated graphics mat illustrated in FIG. 1.

### DETAILED DESCRIPTION

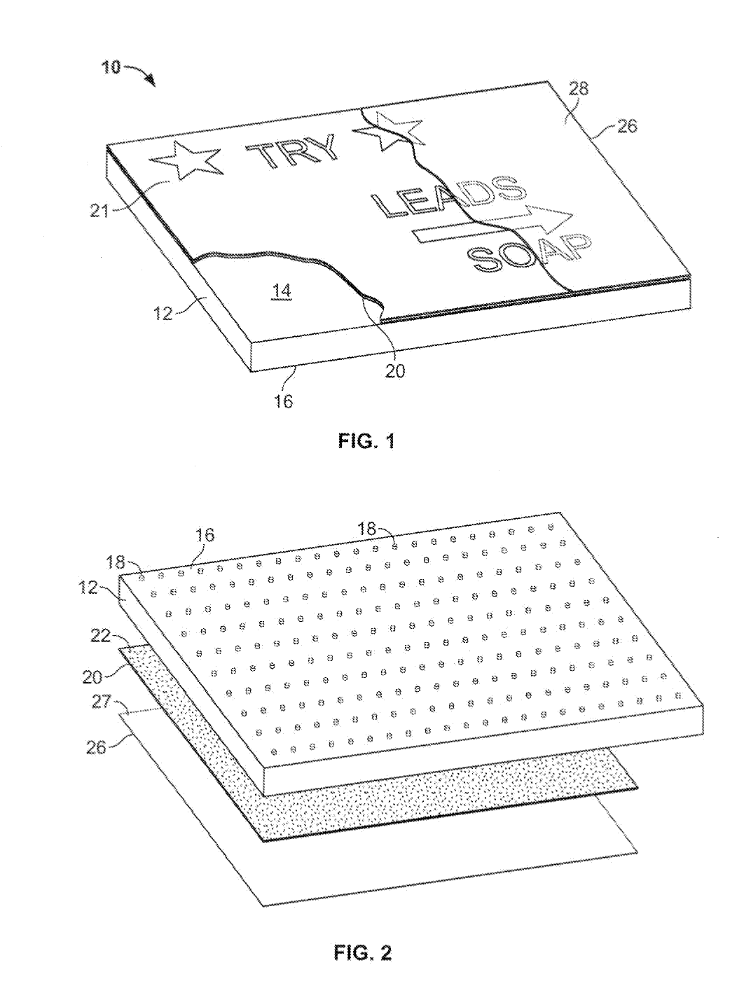

Preferred embodiments of multi-layer graphic mats and processes for making such mats are illustrated in FIGS. 1-3, in which like components have like reference numerals.

FIG. 1 illustrates a cut-away view a preferred multi-layer graphic mat 10 in accordance with the present invention. The mat 10 has a base layer 12, which has first base surface 14 and a second base surface 16. Base layer 12 is preferably made of rubber, such as, for example, nitrile rubber. Such rubber is commercially available, and is generally provided in large rolls that can be handled on roller carts of a type commonly found in print shops for rolls of vinyl and other materials used for signage. Base layer 12 can have any suitable thickness, but preferably has a thickness of from about 30 mil (0.030 inches) to about 150 mil (0.150 inches). First base surface 14 is preferably smooth, with little or no texture. Second base surface 16 is opposite first base surface 14, and usually acts as the contact surface between the multi-layer graphic mat 10 and the surface upon which it is to be displayed. Second base surface 16 can be smooth, or can have texture. In the embodiment illustrated in FIG. 2, second base surface 16 includes a plurality of projecting stubs 18. A texture, such as projecting stubs 18, can enhance the contact between the mat 10 and the surface upon which it is to be displayed, and facilitate the maintenance of the mat 10 in its placement position. For example, a surface such as projecting stubs 18 or cleats is particularly preferred when the graphic mat is to be placed upon a carpeted surface, for carpet surface applications. When the graphic mat is to be placed on a hard floor surface, it is preferred that second base surface 16 be smooth.

Referring to FIGS. 1 and 2, the mat 10 includes an intermediate graphic layer 20 attached to the base layer 12. As illustrated in FIGS. 1 and 2, the intermediate graphic layer 20 has a first intermediate surface 21 and a second intermediate surface 22. As illustrated in FIGS. 1 and 2, the intermediate graphic layer 20 is equal in size to the base layer 12. In other embodiments, the base layer 12 can be larger than the intermediate graphic layer 20. In such embodiments, the first base surface 14 preferably has a window area and a border area, and the intermediate graphic layer 20 is attached to the window area of the first base surface 14. In some embodiments, the base layer 12 can be a pre-molded mat base having a border area and a surface recess that defines the window area. Preferably, when graphic layer 20 is adhered to the window area of base layer 12, the height of first intermediate surface 21 is approximately even with the height of the border area of first base surface 14. Such a configuration, having a a recessed window area, can serve to protect the edges of the graphic layer 20 in high traffic applications. The window area can be an integral part of the base layer 12, or can be a removable component. In such embodiments, the border area of the first base surface 14 can have a texture, such as, for example, a treaded texture, to increase the coefficient of friction between the border area of the first base surface 14 and the feet of people that might walk upon the mat 10.

The intermediate graphic layer can have any suitable thickness, but preferably has a thickness of from about 10 mil (0.010 inches) to about 15 mil (0.015 inches). The intermediate graphic layer is preferably made of a printable sheet material. The printable sheet material of intermediate graphic layer 20 is preferably a rigid, yet flexible, material suitable for printing, and can include, for example, polystyrene and polyvinyl chloride (PVC). A rigid, yet flexible, sheet material facilitates manual assembly of the intermediate graphic layer 20 to the base layer 12 without trapping air bubbles between the layers. Flexible printed vinyl, however, is inappropriate as the flaccidity of vinyl allows the sheet to separate from the rubber backing when the finished product is rolled for shipping and storage.

The first intermediate surface 21 of intermediate layer 20 has graphics thereon. Graphics can include, for example, text, images, shapes, patterns, solid colors, or combinations thereof. As illustrated in FIG. 1, there are graphics on substantially the entire width and height of the first intermediate surface, which can be referred to as being “full bleed” graphics. In some embodiments, the first intermediate surface has a graphics area having a first set of graphics thereon and a border area.

As shown in FIG. 2, second intermediate surface 22 of intermediate graphic layer 20 has an adhesive layer attached thereto or formed thereon, which can be used to attach intermediate graphic layer 20 to base layer 12. Prior to the attachment of intermediate graphic layer 20 to base layer 12, the adhesive layer can be covered by a detachable release liner. Removing the release liner exposes the adhesive coated second intermediate surface 22 of intermediate graphic layer 20 for affixing to the first base surface 14 of base layer 12. Preferably, a laminator is used to remove the release liner and attach the intermediate graphic layer 20 to the base layer 12. Such lamination is preferably accomplished by compression. The adhesive layer preferably allows the intermediate graphic layer 20 to adhere to the base layer 12 such that the mat 10 can be rolled into a compact shape for shipping and storage.

As illustrated in FIGS. 1 and 2, the multi-layer graphic mat 10 also includes an top layer 26 having a first top surface 28 and a second top surface 27. Top layer 26 is preferably made of an optically clear material. The top layer 26 protects the first intermediate surface 21 of the intermediate graphic layer 20, and the graphics thereon. Preferably, top layer 26 also provides a surface having satisfactory non-slip performance, such that people can safely walk on the mat 10. One standard by which the non-slip performance can be measured is ASTM D 2047, which measures the static coefficient of friction of polish-coated flooring surfaces with respect to human locomotion safety. The contents of ASTM D 2047 are hereby incorporated by reference in their entirety. One example of a particularly preferred material from which top layer 26 can be made is FLEX MARK OV 600, available from Flexcon Company, Inc. of Spencer, Mass., which is a flexible clear embossed top sheet available in rolls of differing widths.

As shown in FIG. 2, second top surface 27 of top layer 26 has an adhesive layer attached thereto or formed thereon, which can be used to attach top layer 26 to intermediate graphic layer 20. Prior to the attachment of top layer 26 to intermediate graphic layer 20, the adhesive layer can be covered by a detachable release liner. Removing the release liner exposes the adhesive coated second top surface 27 of top layer 26 for affixing to the first intermediate surface 21 of intermediate layer 20. Preferably, a laminator is used to remove the release liner and attach the top layer 26 to intermediate graphic layer 20. Such lamination is preferably accomplished by compression.

In the embodiment illustrated in FIGS. 1 and 2, the top layer 26 is equal in size to both the intermediate graphic layer 20 and the base layer 12. In embodiments where the base layer 12 is larger than the intermediate layer 20, however, such as described above, the top layer 26 is preferably equal in size to the intermediate graphic layer 20. In some such embodiments, the top layer 26 and the intermediate graphic layer 20 can be attached to each other separately from the base layer 12. In such embodiments, the intermediate graphic layer 20 preferably has a first intermediate surface 21 with graphics thereon and a second intermediate surface 22 having an adhesive layer attached thereto. The top layer 26 is preferably attached to the first intermediate surface 21 of the intermediate layer 20. The adhesive layer attached to the second intermediate surface 22 will stick to either the first top surface of a second top layer or to a rubber base layer. In this manner, graphics originally provided with, or as part of, a mat, can be replaced.

In particularly preferred embodiments, the multi-layer mat 10 can be rolled into a compact shape for shipping and storage in a tube. The mat 10 can then be readily removed from the tube and unrolled to lie on a floor or other surface in proximity to goods or services to be sold. The base layer 12 provides a frictional holding surface against the floor or other surface without chemical adhesive bonding or attaching, while the top layer 26 provides a walkable and skuff resistant surface through which the printed graphics 21 are readily visible.

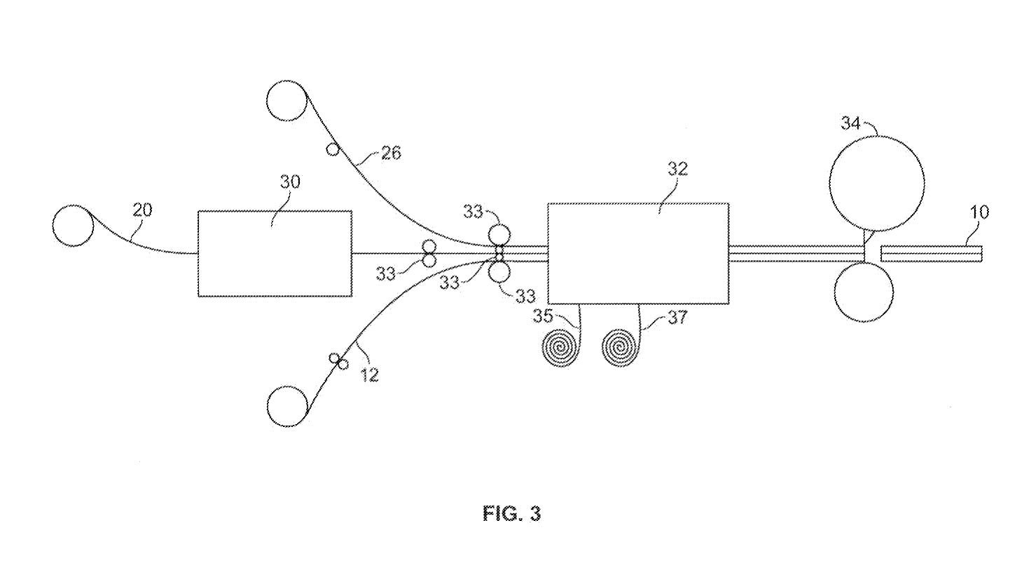

FIG. 3 illustrates a schematic view of a preferred process for manufacturing multi-layer graphic mats of the present invention, such as the mat 10 illustrated in FIGS. 1 and 2.

As illustrated, the process includes providing a base layer material 12, an intermediate graphic layer material 20, and a top layer material 26. The base layer material 12 preferably has a first base surface and a second base surface. The intermediate graphic layer material 20 preferably has a first intermediate surface and a second intermediate surface. The top layer material preferably has a first top surface and a second top surface. Each of the materials can be provided as sheet material in rolls of any suitable length.

The process also includes printing graphics onto the first intermediate surface of the intermediate graphic layer 20. The intermediate graphic layer 20 can be printed with graphics using a large format printer 30 that receives the intermediate graphic layer material 20 for continuous printing. In one example, a 150 foot roll of intermediate graphic layer material 20 having a forty-eight inch width can be printed with fifteen units of a 4 foot by 10 foot graphic display. In various embodiments, the printing can be accomplished by digital printing, such as with ultra-violet ink or solvent based ink, screen printing, or by any other suitable type of printing.

The process further includes laminating the base layer, the intermediate graphic layer, and the top layer to form a multi-layer graphic mat. As illustrated in FIG. 3, the printed intermediate graphic layer material 20 is assembled with the top layer 26 and the base layer 12 to form the mat 10. The leading edge of the intermediate graphic layer 20 is aligned with the leading edge of top layer 26 and with rubber layer 12. The materials are fed into a laminator 32. Preferably, the laminator has rollers 33 that can be used for guiding and controlling the path of the layers. For embodiments where the second intermediate surface of intermediate graphic layer 20 and the second top surface of top layer 26 each have an adhesive layer attached thereto, the laminator 32 preferably peels back the release layer 35 of the intermediate graphic layer 20 and the release layer sheet 37 of the top layer 26. The laminator 32 then presses the material layers together such that the first base surface becomes adhesively attached to the second intermediate surface, and the first intermediate surface becomes adhesively attached to the second top surface. The mats 10 can separated by being cut with blade, such as a knife or a knife roller 34.

From the foregoing, it will be appreciated that although specific embodiments of the invention have been described herein for purposes of illustration, various modifications may be made without deviating from the spirit or scope of the invention. It is therefore intended that the foregoing detailed description be regarded as illustrative rather than limiting, and that it be understood that it is the following claims, including all equivalents, that are intended to particularly point out and distinctly claim the subject matter regarded as the invention.

What is claimed is:

1. A multi-layer graphic mat comprising:
a base layer having a first base surface and a second base surface:
an intermediate graphic layer attached to the base layer, the intermediate graphic layer having a first intermediate surface with graphics thereon and a second intermediate surface; and
a top layer attached to the intermediate layer, the top layer having a first top surface and a second top surface.

2. The multi-layer graphic mat of claim 1, wherein the base layer comprises rubber.

3. The multi-layer graphic mat of claim 2, wherein the base layer comprises nitrile rubber.

4. The multi-layer graphic mat of claim 1, wherein the base layer has a thickness of from about 30 mil to about 150 mil.

5. The multi-layer graphic mat of claim 1, wherein the second base surface comprises a texture.

6. The multi-layer graphic mat of claim 1, wherein the first base surface is smooth.

7. The multi-layer graphic mat of claim 1, further comprising an adhesive layer between the first base surface and the second intermediate surface.

8. The multi-layer graphic mat of claim 1, wherein the intermediate layer comprises polystyrene or polyvinyl chloride.

9. The multi-layer graphic mat of claim 1, wherein the intermediate layer has a thickness of from about 10 mil to about 15 mil.

10. The multi-layer graphic mat of claim 1, further comprising an adhesive layer between the first intermediate surface and the second top surface.

11. The multi-layer graphic mat of claim 1, wherein the first intermediate surface comprises a graphics area having a first set of graphics thereon and a border area.

12. The multi-layer graphic mat of claim 1, wherein the first base surface comprises a window area and a border area, the intermediate graphic layer is attached to the window area of the first base surface, and the top layer is attached to the intermediate graphic layer.

13. The multi-layer graphic mat of claim 12, wherein the border area of the first bottom surface comprises a texture.

14. A process for making a multi-layer graphic mat, the process comprising the steps of:
providing a base layer material having a first base surface and a second base surface;
providing an intermediate graphic layer material having a first intermediate surface and a second intermediate surface;
providing an top layer material having a first top surface and a second top surface;
printing graphics onto the first intermediate surface of the intermediate graphic layer;
laminating the base layer, the intermediate graphic layer, and the top layer to form a multi-layer graphic mat.

15. The process of claim 14, wherein the second intermediate surface and the second top surface each have an adhesive layer attached thereto.

16. The process of claim 14, wherein the first base surface is adhesively attached to the second intermediate surface, and the first intermediate surface is adhesively attached to the second top surface.

17. The process of claim 14, wherein the printing step is accomplished by screen printing or by digital printing.

18. The process of claim 17, wherein the digital printing uses ultra-violet ink or solvent based ink.

19. A multi-layer graphic mat comprising:
an intermediate graphic layer having a first intermediate surface with graphics thereon, and a second intermediate surface having an adhesive layer attached thereto; and
an top layer attached to the intermediate layer, the top layer having a first top surface and a second top surface;
wherein the adhesive layer will stick to either the first top surface of a second top layer or to a rubber base layer.

20. The multi-layer graphic mat of claim 19, wherein the intermediate graphic layer comprises polystyrene or polyvinyl chloride.
